(19) United States
(12) Patent Application Publication
(10) Pub. No.: US 2013/0138510 A1
(43) Pub. Date: May 30, 2013

(54) SYSTEMS AND METHODS FOR FACILITATING ELECTRONIC SALES TRANSACTIONS THROUGH PUBLISHED CONTENT

(71) Applicant: NAVIONICS SPA, Milano (IT)

(72) Inventor: Giuseppe Carnevali, Genova (IT)

(73) Assignee: NAVIONICS SPA, Milano (IT)

(21) Appl. No.: 13/686,348

(22) Filed: Nov. 27, 2012

Related U.S. Application Data
(60) Provisional application No. 61/563,867, filed on Nov. 28, 2011.

(51) Int. Cl. G06Q 30/02

(52) U.S. Cl. CPC G06Q 30/0261
USPC 705/14.58

(57) ABSTRACT

In a method of providing purchasing opportunities linked to geographical locations, a user is provided a graphical user interface for a mobile electronic device comprising a representation of a published work, wherein the published work contains one or more references or representations of goods or services associated with the location of the mobile electronic device. Selectable links are provided within the representation of the published work directly to the one or more sources for obtaining the referenced goods or services. A selection of at least one of the selectable links is received. A sale or offer for sale of the selected one or more goods or services is facilitated.

### RELATED APPLICATIONS

This application is related to and claims benefit of U.S. patent application Ser. No. 13/273,762, filed Oct. 14, 2011, the contents of which is herein incorporated by reference in its entirety.

### FIELD

Embodiments in accordance with principles of inventive concepts relate to methods and systems for marketing, selling, and distributing products and services through electronically distributed media, including media connected with geographical locations. Such geographical connections may be established using electronic location systems, such as Global Positioning Systems (GPS) or other systems, for example.

### BACKGROUND

Systems from which an end user can purchase a product or service from the Internet are typically based on searching for websites of a type or known vendor (such as L.L. Bean, for example) or general merchandiser (such as Amazon, for example), searching for the desired product or service and following the purchase procedures to complete the purchase. Other purchasing avenues include operating through Internet-based advertisements, distinct and separate from most other Internet or published content, to reach a particular vendor and purchase a product or service.

Geographical location and navigation systems, such as Global Positioning Systems (GPS) and other navigation software and systems have greatly improved the ability of operators, including drivers, boaters, and other travelers to navigate. Various GPS systems have also improved the ability of travelers to find various types of services in local areas, including fuel stations, stores, and other types of services. However, finding products or services related to in-depth information corresponding to a geographic location, particularly from published material such as magazine articles, books, video, audio, and newspaper articles, including content requiring a paid fee or subscription, often requires one to independently seek this information such as by visiting a news/book stand and visiting online retail sites (e.g., Amazon, etc. . . . ).

### SUMMARY

Exemplary embodiments in accordance with principles of inventive concepts provide a method for providing purchasing opportunities linked to geographical locations, the method including, providing a user a graphical user interface for a mobile electronic device comprising a representation of a published work, wherein the published work contains one or more references or representations of goods or services associated with the location of the mobile electronic device; providing selectable links within the representation of the published work directly to the one or more sources for obtaining the referenced goods or services; receiving a selection of at least one of the selectable links; and facilitating a sale or offer for sale of the selected one or more goods or services. In accordance with principles of inventive concepts, the published work may be an article and may be a newspaper, magazine, or blog article, for example. Additionally, in accordance with principles of inventive concepts, the published article may be a book, a video, a picture, or a combination of a literary, video, or graphical work, for example.

In accordance with principles of inventive concepts, a representation containing one or more references or representations of goods or services comprises a format of at least one of a PDF, JPEG, PNG, GIF.HTML, XTML, mpeg, and avi file.

In accordance with principles of inventive concepts, a representation containing one or more references or representations of goods or services comprises a proprietary format. Additionally, a representation containing one or more references or representations of goods or services comprises externally provided content. In accordance with principles of inventive concepts, the representation containing one or more references or representations of goods or services comprises streamed content.

In accordance with principles of inventive concepts, references or representation of the goods or services represent an insubstantial portion of the published work.

In accordance with principles of inventive concepts, selectable links are identified by highlighted portions of the representation of the published work.

In accordance with principles of inventive concepts, highlighted portions include a distinguishable background color added to the references or representation of the goods or services, or outlining of the references or representation of goods or services.

In accordance with principles of inventive concepts, highlighted portions include an underlining of a portion of text of the published work.

In accordance with principles of inventive concepts, facilitating a sale or offer for sale of the selected one or more goods or services comprises directing a user to an interface for electronically purchasing the selected one or more goods or services.

In accordance with principles of inventive concepts, interface for electronically purchasing the selected one or more goods or services arranges purchase of the selected one or more goods or services through a vendor of the selected one or more goods or services.

In accordance with principles of inventive concepts, a vendor of the selected one or more goods or services comprises at least one of eBay, iTunes, and Amazon.

In accordance with principles of inventive concepts, an interface for electronically purchasing the selected one or more goods or services comprises a website.

In accordance with principles of inventive concepts, goods or services are from specific vendors and the interface for electronically purchasing the selected one or more goods or services comprises an interface for purchasing the selected one or more goods or services from the specific vendors.

In accordance with principles of inventive concepts, a published work is linked to a geographic location with a geographic positioning device.

In accordance with principles of inventive concepts, a method includes the steps of providing a graphical user interface including a representation of a geographic area, providing selectable identifications of one or more published works relating to locations within the geographic area that contain the one or more references or representations of goods or services, receiving a selection of the one or more published works, facilitating transmission of the one or more published works to computer-readable memory, and facilitating display of the one or more published articles.

In accordance with principles of inventive concepts, a method comprises providing the physical location of the mobile electronic device within the geographic area.

In accordance with principles of inventive concepts, the physical location of a mobile electronic device is provided by a geographic positioning device that is at least one of a GPS locating system and cellular locating system.

In accordance with principles of inventive concepts, providing to a user a graphical user interface includes providing navigation within the geographic area through the geographic positioning device.

In accordance with principles of inventive concepts, the representation of a geographic area comprises a nautical chart representing a body of water.

In accordance with principles of inventive concepts, providing selectable identifications of one or more published articles comprises providing selectable identifications of one or more published articles pertaining to at least one geographic location proximate the physical location of the mobile electronic device.

In accordance with principles of inventive concepts, one or more published articles are related to recreational activities and the one or more references or representations of goods or services are related to the recreational activities.

In accordance with principles of inventive concepts, one or more published articles and goods or services are related to the amenities pertaining to at least one of boating and fishing.

In accordance with principles of inventive concepts, one or more published articles and goods or services are related to at least one of boating accessories, boat maintenance, boat testing, cooking, cruising, diving, fishing, kayaking, lifestyle, power boating, and sailing.

In accordance with principles of inventive concepts, published articles are related to tourism.

In accordance with principles of inventive concepts, the published works are related to at least one of a tourist destination, shopping, and restaurants.

In accordance with principles of inventive concepts, a method includes displaying at least one type of selectable graphical icon representing at least one type of published work, wherein the icon is positioned and displayed within the representation of the geographic area.

In accordance with principles of inventive concepts, a selectable graphical icon is positioned to be over or directly proximal to a particular area within the representation of the geographic area about which the corresponding published work pertains to.

In accordance with principles of inventive concepts, one or more published works are related to the geographic area by at least one of reference in the published work to the geographic area, an activity in the geographic area, or a pre-established relationship.

In accordance with principles of inventive concepts, a method includes providing selectable identifications of one or more published works and goods or services relating to at least one topic, receiving a selection of the one or more published works, facilitating transmission of the one or more published works to computer-readable memory, and facilitating display of the one or more published works.

In accordance with principles of inventive concepts, a method includes providing a graphical user interface that includes providing [a1] to a user a representation of a published work through a mobile electronic device.

In accordance with principles of inventive concepts, a mobile device comprises at least one of a GPS, mobile telephone, hand-held computer, and eReader.

In accordance with principles of inventive concepts, a graphical user interface provides a field for inputting one or more search terms and wherein the method further comprises searching the one or more published works for the one or more search terms and identifying which of the published works contains at least one or more of the one or more inputted search terms.

In accordance with principles of inventive concepts, a method includes identifying which of the published works include one or more of the inputted search terms in the one or more references or representations of goods or services.

In accordance with principles of inventive concepts, a method includes providing selectable links within the representation of the published work to the one or more references or representation of goods or services comprises identifying references or representations of goods or services within the published work and establishing a selectable link to the references or representations of goods or services within the published work.

In accordance with principles of inventive concepts, a method includes identifying the references or representations of goods or services within the published work comprises an automated search of text within the published work for references or representations of the goods or services and establishing a selectable link between the references or representations and the identified goods or services.

In accordance with principles of inventive concepts, a method of providing publications and products and services linked to geographical locations, the method comprising: providing to a user a graphical user interface as a part of an electronic device, the graphical user interface including a representation of a geographic area; providing navigation aids that are linked to the geographic area; providing selectable identifications of one or more published articles related to the geographic area; providing links to references or representations of goods or services within the one or more published articles; receiving a selection of the one or more published articles; facilitating transmission and display of a selected published article; highlighting and permitting a selection of the links to the references of goods and services within the representation of the selected published article; receiving a selection of at least one of the selectable links to the references of goods and services; and facilitating a sale or offer for sale of the selected goods or services.

In accordance with principles of inventive concepts, a method includes providing a geographic positioning system linked to the geographic area, and providing navigation aids that are linked to the geographic area and data from the geographic positioning system.

In accordance with principles of inventive concepts, a method includes providing a purchase option within the graphical user interface and facilitating payment by the user for the steps of facilitating transmission and display of the selected published article.

In accordance with principles of inventive concepts, published articles include at least one of a magazine article, newspaper article, manual, book, video and audio.

In accordance with principles of inventive concepts, goods and services are related to at least one of boat maintenance, boat test, cooking, cruising, diving, fishing, kayaking, lifestyle, power boating, and sailing.

In accordance with principles of inventive concepts, published articles include advertisements for products available within a range of the location of the electronic device.

Systems and methods in accordance with principles of inventive concepts are disclosed for allowing an end user viewing published content and products (hereinafter “products” refers to any marketable products or services) displayed or referred to in that content to be directly connected with a vendor of that product. Exemplary embodiments in accordance with principles of inventive concepts allow vendors to more directly market and sell their products in published content within which their products are identified.

In an exemplary embodiment, an interface is programmed into the computer readable memory of a device so as to highlight a product or type of product in a written or graphical part of a publication so that a user can select the product and be directly guided to a vendor selling the product. In an exemplary embodiment, the identification includes highlighting a portion of published text referencing the product. In an exemplary embodiment, the identification includes highlighting a portion of a published image displaying the product.

In an exemplary embodiment, the highlighted product(s) can be selected by numerous known selection techniques including, for example, tapping or mouse-clicking the highlighted area of text or picture presented on a screen. In an exemplary embodiment, a link to the product is programmed within the system that is processed upon its selection so as to direct the user to a vendor including, for example, a vendor website or other purchasing interface. In various exemplary embodiments in accordance with principles of inventive concepts, such vendor interfaces include that of the maker of the product or, in an exemplary embodiment, a general reseller such as, for example, iTunes, Amazon, or eBay.

In exemplary embodiments in accordance with principles of inventive concepts, the types of publications can include electronically published magazines, articles, manuals, books, video, or other published materials. In various exemplary embodiments in accordance with principles of inventive concepts, the publications are presented in both open and proprietary formats including PDF, JPEG, PNG, GIF.txt, HTML, XTML, mpeg, avi, etc.

In various exemplary embodiments in accordance with principles of inventive concepts, the publications through which the products are linked are presented via standard web pages or through e-readers, video streaming (e.g., YouTube® and NetFlix®), and other applications on either non-mobile or mobile devices such as, for example, mobile phones, tablets, Kindle® or other e-readers, and GPS devices. In an exemplary embodiment, a device from which the content is displayed is a device in which all or substantially all of the computational processing is performed external to the device (e.g., through a “cloud” containing the applications and/or data through which the interfaces operate).

In an exemplary embodiment, embedding links to products and/or the operation of the links are processed through a server. In an exemplary embodiment, the server operates as a source delivering the published content including embedded links that direct a user to a vendor. In an exemplary embodiment, selection of a link by a user is processed by the server, directing the user to an external vendor interface or itself providing a user interface for purchasing a product.

Exemplary embodiments in accordance with principles of inventive concepts described herein provide systems and methods for providing published content and the described product links in relation to geographical locations, for example, geographic locations obtained from geographic positioning systems. In particular, exemplary embodiments in accordance with principles of inventive concepts provide more efficient ways of obtaining in-depth published content about local geographic areas and related products during travel or while planning trips.

In an embodiment, a method of providing published articles linked to geographical locations is provided, the method including the steps of providing to a user a graphical user interface including a representation of a geographic area, providing selectable identifications of one or more remotely published articles relating to locations within the geographic area, receiving a selection of the one or more remotely published articles, facilitating transmission of the one or more remotely published articles to computer-readable memory, and facilitating display of the one or more remotely published articles.

In an exemplary embodiment, the method further comprises providing the physical location of the user within the geographic area. In an exemplary embodiment, providing the physical location of the user is performed through a geographic positioning device. In an exemplary embodiment, the geographic positioning device is at least one of a GPS locating system and cellular locating system. In an exemplary embodiment, providing to a user a graphical user interface comprises providing navigation within the geographic area through the geographic positioning device.

In an exemplary embodiment, the representation of the geographic area comprises a nautical chart representing a body of water.

In an exemplary embodiment, providing the selectable identifications of one or more remotely published articles comprises providing selectable identifications of one or more remotely published articles pertaining to at least one geographic location proximal to the physical location of the user. In an exemplary embodiment, the at least one geographic location proximal to the physical location of the user includes a radius about and inclusive of the physical location of the user.

In an exemplary embodiment, the published articles contain text and images having the above-described links to products or types of products.

In an exemplary embodiment, the one or more published articles are related to recreational activities and the linked products pertain to those recreational activities. In an exemplary embodiment, the one or more published articles are related to at least one of boating, sailing, skiing, hiking, and bicycling. In an exemplary embodiment, the one or more published articles and products are related to the amenities pertaining to at least one of boating and fishing. In an exemplary embodiment, the one or more published articles and products are related to at least one of boating accessories, boat maintenance, boat testing, cooking, cruising, diving, fishing, kayaking, lifestyle, power boating, and sailing.

In an exemplary embodiment, the published articles and products are related to tourism. In an exemplary embodiment, the published articles and products are related to at least one of a tourist destination, shopping, and restaurants.

In an exemplary embodiment, the published articles are comprised of at least of one of a magazine article, newspaper article, book, video and audio.

In an exemplary embodiment, the step of providing selectable identifications of one or more remotely published articles and product links comprises connecting to a remote server from which the identifications of one or more remotely published articles and products are retrieved.

In an exemplary embodiment, the server is configured to have an account for the user and is configured to permit the transmission and display of the selected one or more remotely published articles and product links on a plurality of devices through a login into the account.

In an exemplary embodiment, the method further includes the step of providing a purchase option within the graphical user interface and facilitating payment by the user for the steps of facilitating transmission and display of the selected one or more remotely published articles and/or purchase of a linked product.

In an exemplary embodiment, the step of facilitating transmission of the selected one or more remotely published articles and product links comprises facilitating transmission of the selected one or more remotely published articles and product links directly from the publisher. In an exemplary embodiment, a server separate from that of the publisher embeds the links to the identified products.

In an exemplary embodiment, the step of facilitating display of the selected one or more remotely published articles and product links comprises facilitating display of the selected one or more remotely published articles and product links from within a web browser.

In an exemplary embodiment, the step of facilitating display of the selected one or more remotely published articles and product links comprises facilitating display of the selected one or more remotely published articles from a mobile device.

In an exemplary embodiment, the step of facilitating display of the selected one or more remotely published articles and product links comprises facilitating display of the selected one or more remotely published articles and product links from at least one of a cell phone, a tablet, and an electronic reader.

In an exemplary embodiment, the step of facilitating display of the selected one or more remotely published articles and product links comprises facilitating concurrent display of the selected one or more remotely published articles from a plurality of devices.

In an exemplary embodiment, the step of displaying transmission of the selected one or more remotely published articles and product links comprises facilitating display of the selected one or more remotely published articles from within said graphical user interface.

In an exemplary embodiment, the graphical user interface permits the user to sort the selectable identifications of one or more remotely published articles and product links by categories of article.

In an exemplary embodiment, the method including tracking the frequency of selections of particular publications and product links and storing the frequency of selections in computer readable memory and wherein the wherein the step of providing selectable identifications of one or more remotely published articles and product links comprises providing a list of the most frequently selected publications.

In an exemplary embodiment, the graphical user interface provides an option for identifying one or more remotely published articles and product links as a favorite and storing the identifications as favorites in computer readable memory and wherein the step of providing selectable identifications of one or more remotely published articles and product links comprises providing a list of the publications identified as favorites.

In an exemplary embodiment, the graphical user interface provides a field for inputting one or more search terms and wherein the method further comprises searching the one or more remotely published articles and product links for the one or more search terms and identifying which of searched articles contains at least one or more of the one or more inputted search terms.

In an exemplary embodiment, the method includes a step of displaying at least one type of selectable graphical icon representing at least one type of article or product, wherein the icon is positioned and displayed within the representation of the geographic area. In an exemplary embodiment, the selectable graphical icon is positioned to be over or directly proximal to a particular area within the representation of the geographic area about which the corresponding article is written.

In an aspect of inventive concepts, a method of providing publications and products linked to geographical locations is provided, the method including the steps of providing to a user a graphical user interface including a representation of a geographic area, providing a geographic positioning system linked to the geographic area, providing navigation aids that are linked to the geographic area and data from the geographic positioning system, providing selectable identifications of one or more published articles and product links relating to locations within the geographic area, receiving a selection of the one or more published articles, facilitating transmission of the one or more published articles and product links to computer-readable memory, and facilitating display of the one or more published articles and product links within a graphical user interface.

In an exemplary embodiment, the navigation aids display information about at least the geographic position within the geographic area, a direction of movement, a speed of movement, and an indicator of the direction of travel required to reach a pre-programmed destination.

In an exemplary embodiment, the selectable identifications of one or more published articles and product links are related in particular to a destination selected within the graphical user interface.

In an exemplary embodiment, the method includes the step of providing a purchase option within the graphical user interface and facilitating payment by the user for the steps of facilitating transmission and display of the selected one or more remotely published articles and product links.

In an exemplary embodiment, the published articles and product links include at least of one of a magazine article, newspaper article, manual, book, video and audio.

In an exemplary embodiment, the one or more published articles are related in particular to one of boat maintenance, boat test, cooking, cruising, diving, fishing, kayaking, lifestyle, power boating, and sailing.

In an aspect of inventive concepts, a system for providing published articles and products linked to geographical locations is provided, the system including a server configured to facilitate the display of remotely published articles and product links within an application installed on a mobile device. The application is programmed in the computer readable memory of the mobile device to display a graphical user interface including a representation of a geographic area, display selectable identifications of one or more remotely published articles and product links relating to locations within the geographic area, receive a selection from the user of the one or more remotely published articles, receive a transmission of the one or more selected articles and product links and to store the transmission in the computer-readable memory of the mobile device, and display the selected published articles.

In an exemplary embodiment, the application is further programmed in the computer-readable memory of the mobile device to receive navigation data from a geographic positioning system. In an exemplary embodiment, the application is further programmed in the computer-readable memory of the mobile device to provide navigation aids that display information about at least the geographic position within the geographic area, a direction of movement, a speed of movement, and an indicator of a direction of travel to reach a pre-programmed destination. In an exemplary embodiment, the representation of the geographic area comprises a nautical chart representing a body of water and wherein providing navigation aids includes providing navigation aids relating to navigating the body of water.

In an exemplary embodiment, the selectable identifications of one or more remotely published articles and product links are related to a destination selected within the graphical user interface. In an exemplary embodiment, the selectable identifications of the one or more published articles and product links are related to the geographic areas proximal to the physical location of the user.

In an exemplary embodiment, the geographic positioning system is at least one of a GPS and cellular locating system.

In an exemplary embodiment, the application is further programmed in the computer-readable memory of the mobile device to provide a purchase option within the graphical user interface and to facilitate payment by the user for transmission and display of at least one of the selected remotely published articles and or linked products.

In an exemplary embodiment, the remotely published articles are comprised of at least of one of a magazine article, newspaper article, manual, book, video, and audio.

In an exemplary embodiment, the remotely published articles pertain to at least one of boating and fishing.

In an exemplary embodiment, the remotely published articles and product links are related to at least one of a tourist destination, shopping, and restaurants.

In an exemplary embodiment, the identifications of one or more remotely published articles and product links are stored on the server and the application is further programmed in the computer-readable memory of the mobile device to download the identifications of the one or more remotely published articles and product links from the server.

In an exemplary embodiment, the one or more remotely published articles and product links are stored on the server and the application is further programmed in the computer-readable memory of the mobile device to download the one or more remotely published articles from the server.

In an exemplary embodiment, the server is further configured to have an account system for a user and is configured to permit the transmission and display of the selected one or more remotely published articles and product links on a plurality of devices through a login in the account system.

In an exemplary embodiment, the application is further programmed in the computer-readable memory of the mobile device to display the selected published articles and product links in a web browser.

In an exemplary embodiment, the application is further programmed in the computer-readable memory to provide a user selectable option for identifying one or more remotely published articles and product links as favorites and wherein the application is programmed to provide selectable identifications of the favorite published articles and product links within the graphical user interface.

In an exemplary embodiment, the graphical user interface is programmed for inputting one or more search terms from the user and wherein the application is programmed to search the one or more remotely published articles and product links for one or more inputted search terms and identifying which of searched articles contains at least one or more of the inputted search terms and/or links to products or categories of products.

In an exemplary embodiment, the graphical user interface is programmed to display at least one type of selectable graphical icon within the representation of the geographic area, each icon representing a remotely published article, and the position of the icon within the representation of the geographic area indicating a geographic area to which the article is linked.

In the context of exemplary embodiments in accordance with principles of inventive concepts, the term “published” includes not only conventional publishing, such as online-magazines, newspapers, newsletters, blogs, online catalogs, online travel guides such as Frommer, Michelin, or Zagat, rating websites such as Yelp, social networks, general websites, search websites, and browsers, but any document or page available through electronic means, including, but not limited to, subscription services that may be specifically adapted for geo-local merchandising, for example.

### BRIEF DESCRIPTION OF THE DRAWINGS

The foregoing and other objects, features and advantages of exemplary embodiments in accordance with principles of inventive concepts will be apparent from the more particular description of exemplary embodiments, as illustrated in the accompanying drawings in which like reference characters refer to the same elements throughout the different views. The drawings are not necessarily to scale, emphasis instead being placed upon illustrating the principles of the inventive concepts in the drawings.

FIG. 1 is a high level block diagram of a system for distributing publications linking identified products to an interface for purchasing the products according to an exemplary embodiment of inventive concepts.

FIG. 2 is an event time flow diagram of a system for distributing publications linking identified products to a vendor interface which sells the products according to an exemplary embodiment of inventive concepts.

FIG. 3A is a screen shot of the title page of a publication including links to vendors of identified products in an exemplary embodiment of inventive concepts.

FIG. 3B is a screen shot of a picture being selected from the publication of FIG. 3A.

FIG. 3C is a screen shot of the selected picture of FIG. 3B including identifiers of products that can be and are selected for presentation of purchasing options according to an exemplary embodiment of inventive concepts.

FIG. 3D is a screen shot of a vendor interface for purchasing a selected product that is displayed after selection of an identified product from FIG. 3C, according to an exemplary embodiment of inventive concepts.

FIG. 3E is a screen shot of the selected picture of FIG. 3C, wherein another product is selected for presentation of purchasing options.

FIG. 3F is a screen shot of another vendor interface for purchasing an identified product that is displayed after selection of the product as shown in FIG. 3E, according to an exemplary embodiment of inventive concepts.

FIG. 4 is a high level block diagram of a system for distributing publications linked to geographic locations and that link identified products to an interface for purchasing the products according to an exemplary embodiment of inventive concepts.

FIGS. 5A-5C are screen shots of an interface for listing and selecting published articles linked to a geographic area according to exemplary embodiments in accordance with principles of inventive concepts.

FIGS. 5D-5E are screen shots of an interface for viewing and selecting articles from categories and a categorized list, respectively, of published articles according to exemplary embodiments in accordance with principles of inventive concepts.

FIG. 5F is a screen shot of an article with highlighted and selected text linking the products identified in the text to a purchasing interface according to exemplary embodiments in accordance with principles of inventive concepts.

FIG. 5G is a screen shot of a vendor purchasing interface displayed after the selection of the highlighted text shown in FIG. 5F according to exemplary embodiments in accordance with principles of inventive concepts.

### DETAILED DESCRIPTION

The foregoing and other objects, features and advantages of the exemplary embodiments of inventive concepts will be apparent from the more particular description of exemplary embodiments of inventive concepts, as illustrated in the accompanying drawings in which like reference characters refer to the same parts throughout the different views. The drawings are not necessarily to scale, emphasis instead being placed upon illustrating the principles of inventive concept in the drawings.

The terminology used herein is for the purpose of describing particular exemplary embodiments in accordance with principles of inventive concepts and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be teemed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

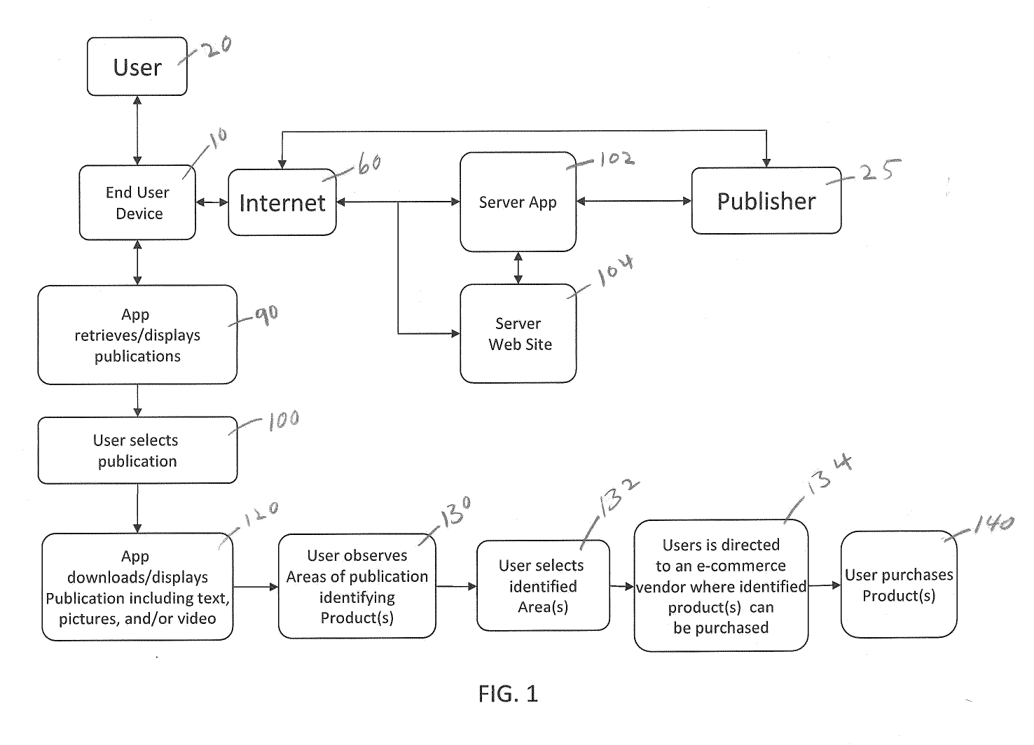

FIG. 1 is a high level block diagram of a system for distributing publications linking identified products to an interface for purchasing the products, and, in particular, for distributing publications to end-users in a particular geographic area, or within a range of a location from which the products may be obtained, according to exemplary embodiments in accordance with principles of inventive concepts. In an exemplary embodiment, a Server Application 102 is programmed in computer readable memory of a device to allow a user 20 to retrieve and subsequently display publications, within which portions of text, images, video, or even audio may be highlighted or otherwise emphasized to identify products available for purchase. In an exemplary embodiment, the Server Application 102 is programmed for permitting a user 20 to select an identified product and directing a user 20 to an interface for purchasing the identified products. In an exemplary embodiment, the publications with links to identified/selectable products can be retrieved from a central Server. In an exemplary embodiment, the publications can be retrieved directly from the Publisher 25 through the Server Application 102 or a website 104.

In an exemplary embodiment, when a user 20 selects such an identified product within a displayed publication, the Server Application 102 triggers the server to direct the user 20 to an interface for purchasing the product. In various exemplary embodiments, the interface is provided by the Server Application 102 on the device which can communicate with the Server or with a vendor. In an exemplary embodiment, the interface is provided through a website 104 programmed within the Server to which the user 20 is directed. In an exemplary embodiment, the interface is provided through an interface provided by another vendor or retailer of the product to which the user 20 is directed by the Server Application 102 and/or Server. In an exemplary embodiment, the user 20 is provided a choice as to which interface (e.g., from the Server, Manufacturer, or Reseller; from an App or browser) they are directed to for purchasing products.

In an exemplary embodiment, a system in accordance with principles of inventive concepts includes an end-user device 10, operated by a user 20. The end-user device may be installed with an application (also referred to as an “App”) that is programmed with a graphical user interface (GUI) to display a geographic area (e.g., a graphically rendered map or chart). In various exemplary embodiments, the mobile device 10 can be a “smart” phone, tablet, laptop, electronic plotter, e-reader, or other mobile device, for example.

In an exemplary embodiment in accordance with principles of inventive concepts, the App of the mobile device 10 is programmed to find and present (for example, in list form) published articles linked to a particular geographic area (as referred to in process step 90). The particular geographic area may be an area proximate the physical location of the mobile device 10 (e.g., within a certain radius of the physical location) or, for example, an area selected manually by the user 20. Determining the physical location of the mobile device may be accomplished via GPS or through other methods, such as, for example, cellular signal positioning techniques that are known to those of ordinary skill in the art. The user 20 can select an article from those presented to download and display, as referred to in process step 100. In an exemplary embodiment, permission (e.g., a license) to download and display the publication can be purchased through the GUI programmed into the App or, in an exemplary embodiment, be purchased through a separate application (e.g., a web browser) to which the App can direct the user 20. In an exemplary embodiment, after downloading, the publication is displayed within and can be viewed from the App GUI (referred to in a process step 120) in which the publication includes links to products in, for example, text, images, video and/or audio. In an exemplary embodiment, the publication can be displayed in a separate application (e.g., a web browser or electronic reader). In an exemplary embodiment, the publication is downloaded to the mobile device (e.g., computer-readable memory) or an attached data storage device and made available on the device for later viewing without further downloading necessary. In an exemplary embodiment, the publication, product links, and/or both are stored on an external server from where the mobile device can access and display the publication and links.

Certain regions within a publication, or portion (for example, a page) of a publication, may include emphasis (highlighting, outlining, or flashing, for example) to indicate that the emphasized region or regions include an item or items that may be purchased. In particular, the emphasis may indicate that the item (or items) included within the emphasized region(s) may be purchased within a geographical region proximate the mobile device (or user-selected geographical region, such as a region the user anticipates visiting), or, the item may have a connection to the geographical region (for example, a woven basket may have a connection to Nantucket, Mass., or a wooden boat may have a connection to Brooklin, Me.). In an exemplary embodiment in accordance with principles of inventive concepts, a user may observe areas of a publication identifying such products (referred to in process step 130). After observing such an area a user may select an identified/emphasized area (referred to in process step 132), for example, by directing a pointer to the identified area (for example, mousing over) and activating (for example, clicking on) the area. After selecting the area the user may be directed to a vendor, such as an e-commerce vendor, where the selected products may be purchased (referred to in process step 134). Once directed to the vendor, the user may execute a purchase of the product (referred to in process step 140).

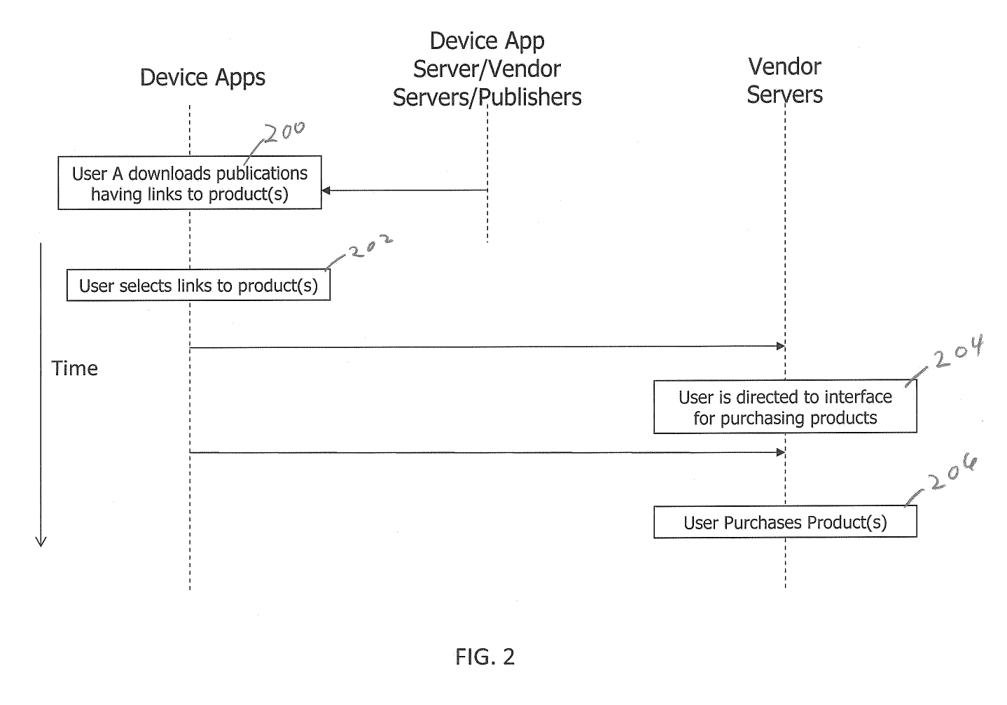

FIG. 2 is an event time flow diagram of a system for distributing publications linking identified products to a vendor interface which sells the products according to an exemplary embodiment of inventive concepts. In an exemplary embodiment, a user 20 first downloads publications including selectable links to products within the publications (referred to in process step 200). The user 20 may then select a link to a product (referred to in process step 202), after which the user 20 is directed to an interface (referred to in process step 204) allowing the user 20 to purchase the product (referred to in process step 206).

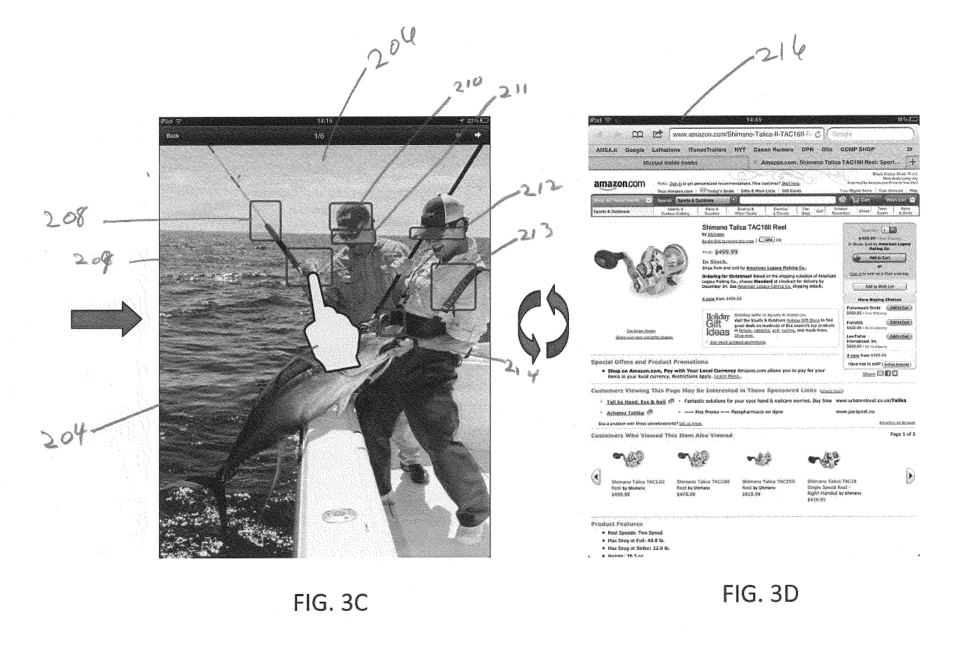

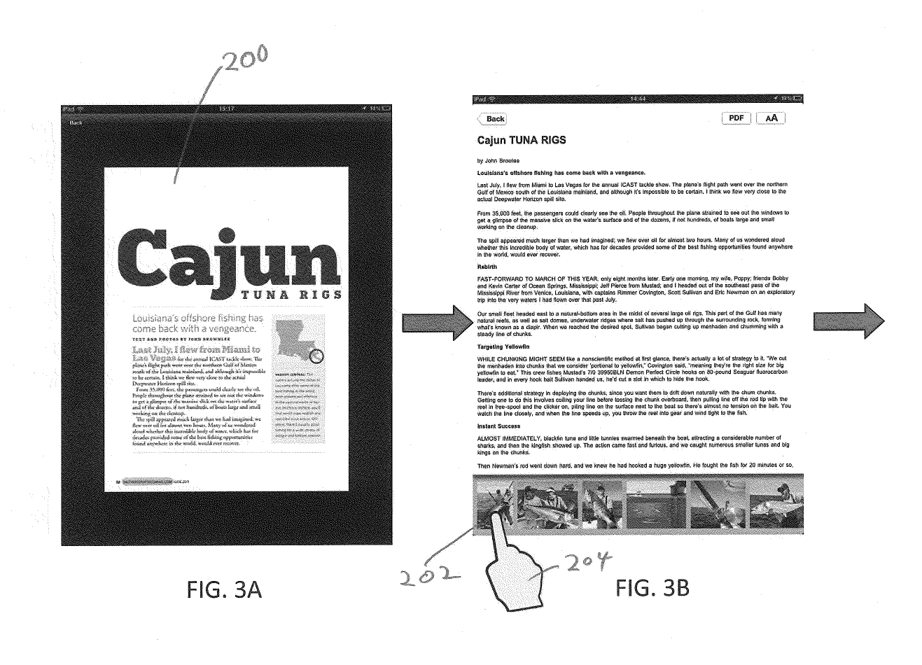

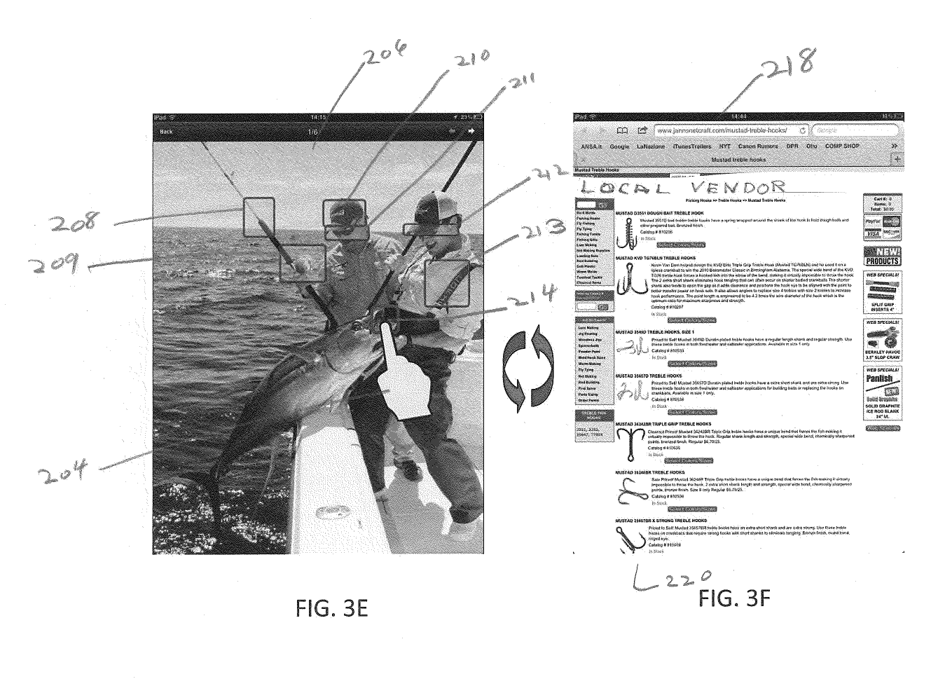

FIG. 3A is a screen shot 200 of the title page of a publication including links to vendors of identified products in an exemplary embodiment in accordance with principles of inventive concepts. FIG. 3B is a screen shot of a picture 202 being selected from the publication of FIG. 3A, with a pointed-finger icon 204 moved to an image for product selection. In exemplary embodiments in accordance with principles of inventive concepts, links to identified products can be found within portions of a publication discussing topics related to the products such as, for example, fishing. In an exemplary embodiment, a publication includes images individually selectable and viewable such as one selected within FIG. 3B and shown in greater detail in FIG. 3C.

FIG. 3C is a screen shot 206 of the selected picture of FIG. 3B including identifiers 208-214 of products. In this exemplary embodiment in accordance with principles of inventive concepts, displayed products are emphasized by outlining them, thus identifying the products available for purchase. As previously indicated, emphasized products may be selected by, for example, mousing over the image region of the emphasized product and clicking on that region of the image. After such selection a user may be presented with purchasing options according to an exemplary embodiment of inventive concepts.

FIG. 3D is a screen shot 216 of a vendor interface for purchasing a selected product that is displayed after selection of an identified product from FIG. 3C, according to an exemplary embodiment of inventive concepts. For example, various products or types of products may be highlighted and selectable such as in the manner shown in FIG. 3C including, for example, a fishing rod, a reel, tackle, hats, a harness, etc. In accordance with principles of inventive concepts, products that are presented are “geo-local.” That is, presented products are either available proximate (that is, within a preselected or user-selected radius of) the location of the end user device 10 (or within a region selected by an end-user) or are associated with the location (for example, a salt water fishing reel associated with Georges Banks). After a user 20 selects a product such as the selected reel shown in FIG. 3C, the user 20 is directed to an interface for purchasing reels including, for example, the specific reel shown in FIG. 3C and/or other types of reels including those shown in FIG. 3D. In an exemplary embodiment, the interface for purchasing products or services can be provided through the application which communicates with a purchasing server, through an external website 104 provided by the server or a vendor. In an exemplary embodiment, the application or server conducts a search for a vendor for selected product(s) or service(s) and, in an exemplary embodiment, categorizes and presents a purchasing interface of products by price, location, availability, and/or other characteristics.

FIG. 3E is a screen shot of the selected picture of FIG. 3C, wherein another product (a fishing hook) is selected for presentation of purchasing options. FIG. 3F is a screen shot 218 of another vendor interface for purchasing an identified product that is displayed after selection of the product as shown in FIG. 3E, according to an exemplary embodiment of inventive concepts. In an exemplary embodiment in accordance with principles of inventive concepts, the vendor may be a vendor proximate the location of the end user device 10. After a user 20 selects a product such as the tackle shown in FIG. 3E, the user 20 is directed to an interface for purchasing tackle including, for example, the specific tackle shown in FIG. 3E and/or other types of tackle (for example, items in list 220) including those shown in FIG. 3F.

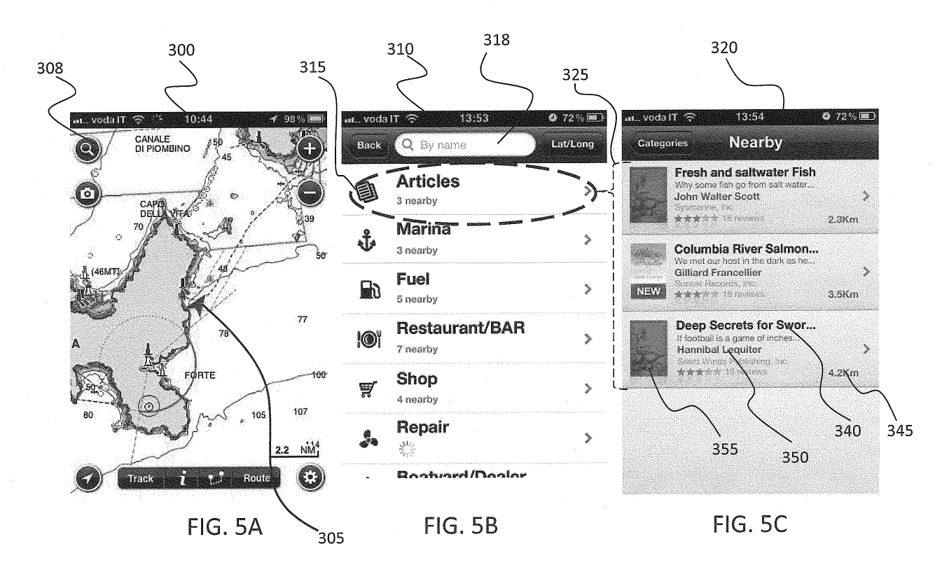

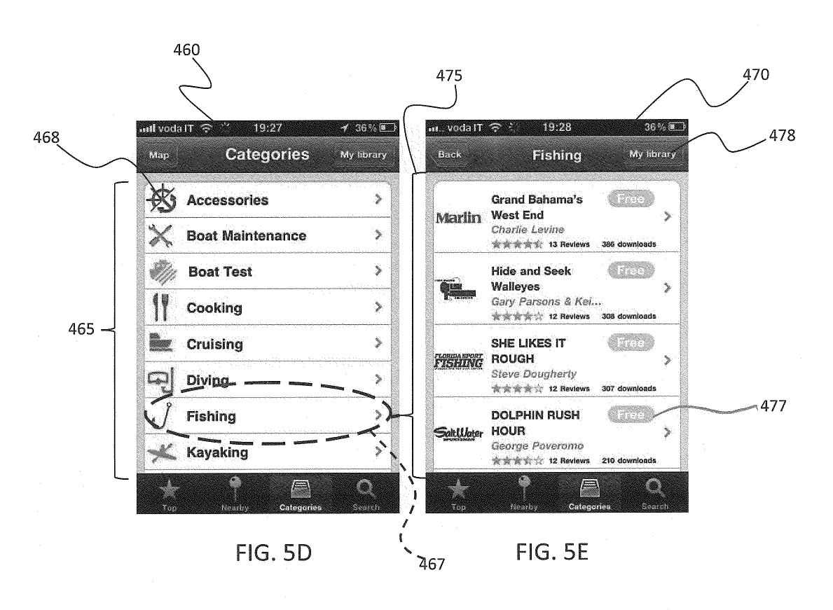

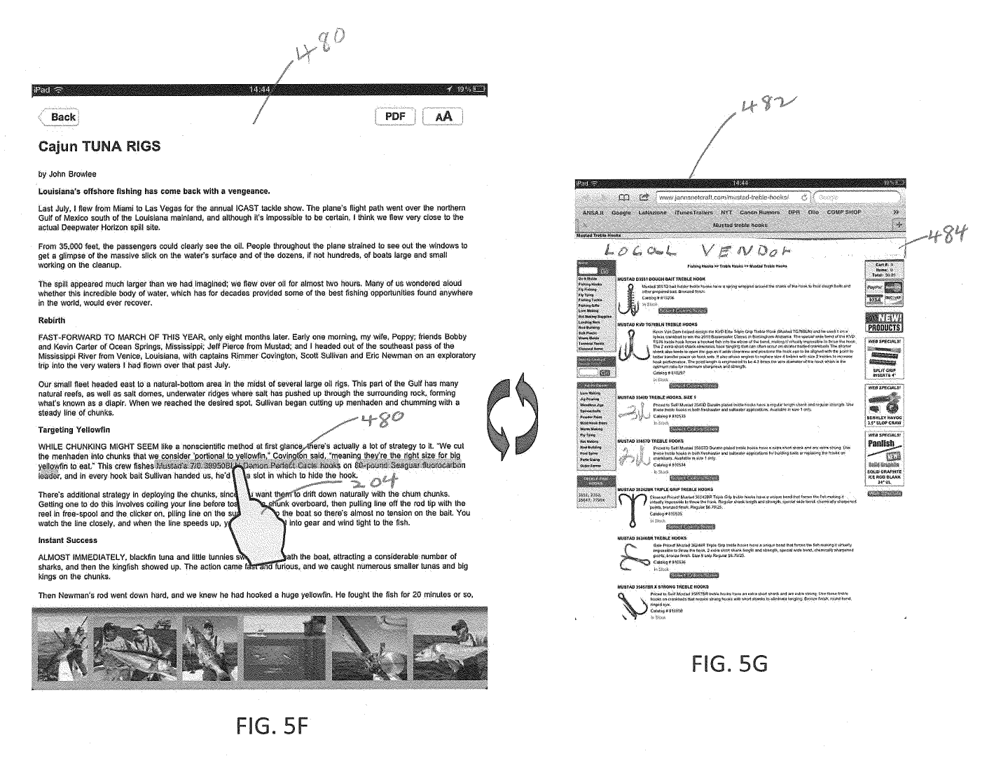

In other exemplary embodiments, links to vendors of products or services associated with an article or other publication can be identified in other ways. For example, links associated with highlighted/emphasized portions of text in an article or web content can be provided to identify link vendors, or links associated with highlighted portions of text in an image or video within the article, web content, or other publication such as, for example, in reference to FIGS. 5F-5G described below.

In an exemplary embodiment, where a selectable product is identified in a video, for example, a user 20 can select the identification during video play or by pausing the video and selecting the identified product while paused or during playback of the video.

In various exemplary embodiments, selection of the identified products can be performed through various known devices including touchscreens, trackballs, mice, stylus, etc.

In other exemplary embodiments, product selection and/or purchase through the system can be performed by voice commands such as, for example, “select fishing rod.”

In other exemplary embodiments, the published content is in part or entirely audio in which, for example, a voice or other command could select a product or service identified in the audio.

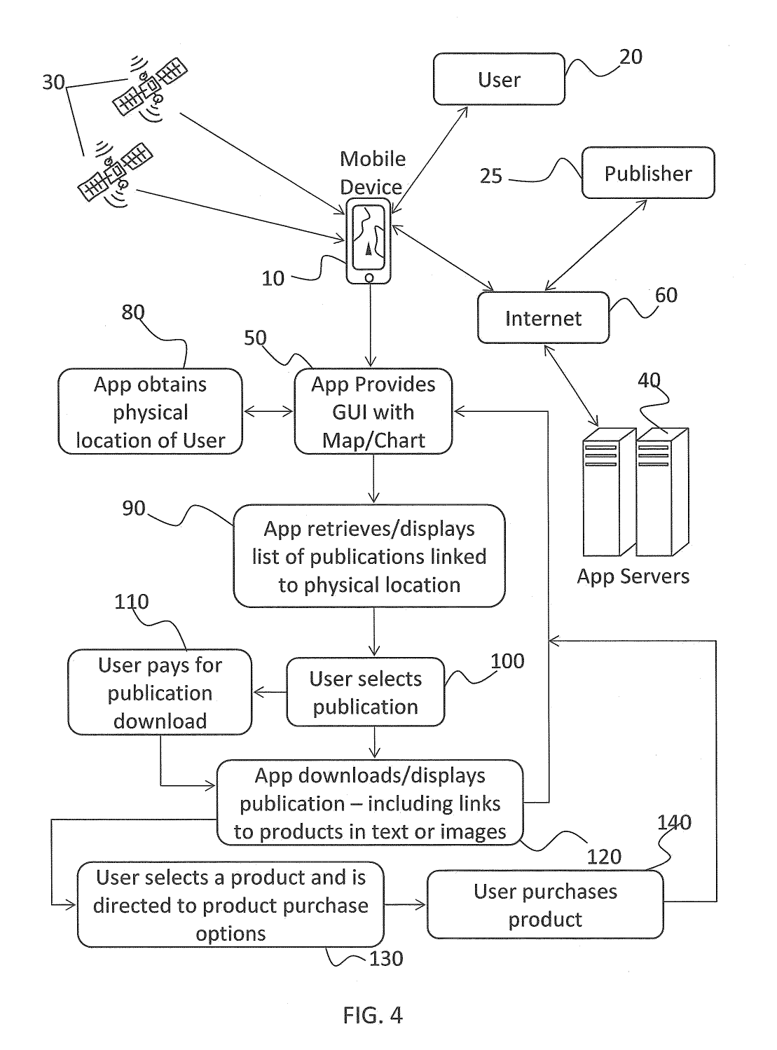

FIG. 4 is a high level block diagram of an exemplary embodiment of a system for distributing publications and/or products linked to geographic locations in accordance with principles of inventive concepts. The system also links identified products to an interface for purchasing products according to an exemplary embodiment of inventive concepts. In an exemplary embodiment, the system includes a mobile device 10 operated by a user 20 installed with an application (also referred to as an “App”) that is programmed with a graphical user interface (GUI) to display a geographic area (e.g., a graphically rendered map or chart) as identified in a process step 50. In various exemplary embodiments, the mobile device 10 can be a “smart” phone, tablet, laptop, electronic plotter, e-reader, or other mobile devices.

The App of the mobile device 10 is programmed to find and list published articles linked to a particular geographic area (as referred to in a process step 90). In an exemplary embodiment, the particular geographic area is an area proximate to the physical location of the mobile device 10 (e.g., within a certain radius of the physical location) or, for example, an area selected manually by the user 20. Determining the physical location of the mobile device, such as referred to in a process step 80, can be accomplished via a GPS (e.g., from GPS satellites 30) or through other methods including, for example, cellular signal positioning techniques that are known to those of ordinary skill in the art. From the list of published articles, the user 20 can select an article to download and display, as referred to in a process step 100. In an exemplary embodiment, permission (e.g., a license) to download and display the publication can be purchased through the GUI programmed into the App or, in an exemplary embodiment, be purchased through a separate application (e.g., a web browser) to which the App can direct the user 20. In an exemplary embodiment, after downloading, the publication is displayed within and can be viewed from the App GUI (referred to in a process step 120) in which the publication includes links to products in, for example, text, images, video and/or audio. In an exemplary embodiment, the publication can be displayed in a separate application (e.g., a web browser or electronic reader). In an exemplary embodiment, the publication is downloaded to the mobile device (e.g., computer-readable memory) or an attached data storage device and made available on the device for later viewing without further downloading necessary. In an exemplary embodiment, the publication, product links, and/or both are stored on an external server from where the mobile device can access and display the publication and links.

In an exemplary embodiment, purchasing and downloading publications for display is managed via a server (e.g., of Servers 40) which, together with the mobile device 10, can be connected to and communicate via the Internet 60. In an exemplary embodiment, the one or more servers 40 manage product links embedded within the publications and can, for example, update such links within viewable publications such as to which products are identified for purchase and where a user 20 can be directed to purchase the product. In an exemplary embodiment, one or more Servers 40 are programmed to provide user accounts for particular users, who can log into and, through these accounts, purchase the ability to download and display the publications. In an exemplary embodiment, the listings of publications available for download are stored by and accessed through the server and, in a further exemplary embodiment, the publications themselves are stored by the server. In an exemplary embodiment, permissions to download publications and/or the publications themselves can be acquired directly through a publisher 25 or authorized distributors (e.g., Amazon Kindle, iTunes, etc.). In an exemplary embodiment, once purchased, viewing of a publication can be made accessible on more than one device such as, for example, different mobile devices and/or a desktop computer. In an exemplary embodiment, the App can operate on a non-mobile device such as a desktop computer.

In an exemplary embodiment, the publication is an article such as from a magazine or website 104, an article from a newspaper or news site, or a book. In an exemplary embodiment, the publications are related to boating accessories, boat maintenance, boat testing, cooking, cruising, diving, fishing, kayaking, lifestyle, power boating, and/or sailing. In an exemplary embodiment, the publications are related to any recreational activities or tourist activities and destinations including, for example, restaurants, inns, and other accommodations.

In various exemplary embodiments, the publications are linked or related to a geographical area by a reference to the geographical area within the publication, by a type of activity (e.g., sailing, fishing) that occurs in the geographic area, and/or by a predetermined or pre-established geographical relationship to the publication that is, for example, tracked/compiled by a server or other source.

In an exemplary embodiment, once a publication is displayed, a user 20 can select a highlighted portion of a publication linking/identifying a product for sale and is directed to product purchase options (e.g., a purchase interface) such as in step 130 and further described in various exemplary embodiments herein. From a purchase interface, a user 20 can purchase a product such as referred to in step 140 and in further detail with respect to various exemplary embodiments described herein.

FIGS. 5A-5C are screen shots of an interface for listing and selecting published articles linked to a geographic area according to exemplary embodiments in accordance with principles of inventive concepts. FIG. 5A is a screen shot 300 of a GUI showing a nautical chart including a geographic area represented by an arrow designator 305. A search button 308 can be clicked to conduct a search of items linked to the designated geographic area, including published articles. FIG. 5B is a screen shot 310 of a selectable menu list including an “Articles” selection option 315 for displaying searched and identified available articles linked to the geographic region indicated by designator 305, which can be displayed, for example, in response to clicking the search button 308 of FIG. 5A. The GUI of screen shot 310 further includes a search input field 318 in which a user 20 can input search terms to be searched within the geographically linked items found through the application, including the names of published articles. FIG. 5C is a screen shot of a selectable menu list 325 of the geographically linked articles found through the application that can be displayed, for example, in response to selecting the “Articles” selection option 315 of FIG. 5B. Each menu item listed from the selectable menu list 325 displays an article title such as title 340, an article author such as author 350, and, if available, an associated icon such as icon 355 and a distance, such as distance 345, from the presently identified or selected geographic location within a geographic area about designator 305 of FIG. 5A. In an exemplary embodiment, a price (not shown) is also displayed within each applicable menu item if purchase is required for viewing the corresponding article.

FIGS. 5D-5E are screen shots of an interface for viewing and selecting articles from categories and a categorized list, respectively, of published articles according to exemplary embodiments in accordance with principles of inventive concepts. FIG. 5E is a screen shot 460 of a selectable list 465 of various categories within which found articles can be sorted by. FIG. 5F is a screen shot of a selectable list 475 of found articles sorted by the “Fishing” category after selection of a Fishing category option 467 of FIG. 5E. A “Free” label 477 indicates that a selectable article is free for download/display. A “My library” button 478 directs the user 20 to a GUI (not shown) including a selectable listing of already downloaded/purchased articles ready for display.

FIG. 5F is a screen shot 480 of an article with highlighted 482 and selected 204 text linking the products identified in the text to a purchasing interface according to exemplary embodiments in accordance with principles of inventive concepts. FIG. 5G is a screen shot 482 of a vendor purchasing interface displayed after the selection of the highlighted text shown in FIG. 5F according to exemplary embodiments in accordance with principles of inventive concepts. As previously described, the vendor may be a geo-local vendor 484. That is, the vendor may be located proximate the location of end user device 10. In an exemplary embodiment, the highlighted text represents a hyperlink or similar linking mechanism triggered by selection of the highlighted area. Similar mechanisms can be embedded in images or video in order to direct a user 20 to a purchasing interface upon selection of the identified product or service.

While exemplary embodiments in accordance with principles of inventive concepts have been particularly shown and described with references to exemplary embodiments thereof, it will be understood by those skilled in the art that various changes in form and details may be made herein without departing from the spirit and scope of the inventive concepts as defined herein.

What is claimed is:

1. A method of providing purchasing opportunities linked to geographical locations, the method comprising the steps of
providing a user a graphical user interface for a mobile electronic device comprising a representation of a published work, wherein the published work contains one or more references or representations of goods or services associated with the location of the mobile electronic device;
providing selectable links within the representation of the published work directly to the one or more sources for obtaining the referenced goods or services;
receiving a selection of at least one of the selectable links; and
facilitating a sale or offer for sale of the selected one or more goods or services.

2. The method of claim 1 wherein the published work is at least one of an article, a newspaper article, a magazine article, a book, a video, a picture, a literary work, a video work, or a graphical work.

3. The method of claim 1, wherein the representation containing one or more references or representations of goods or services comprises a format of at least one of a PDF, JPEG, PNG, GIF.HTML, XTML, mpeg, and avi file.

4. The method of claim 1, wherein the representation containing one or more references or representations of goods or services comprises a proprietary format.

5. The method of claim 1, wherein the representation containing one or more references or representations of goods or services comprises externally provided content.

6. The method of claim 1, wherein the representation containing one or more references or representations of goods or services comprises streamed content.

7. The method of claim 1 wherein the references or representation of the goods or services represent an insubstantial portion of the published work.

8. The method of claim 1, wherein the selectable links are identified by highlighted portions of the representation of the published work.

9. The method of claim 8, wherein the highlighted portions include a distinguishable background color added to the references or representation of the goods or services.

10. The method of claim 9, wherein the highlighted portions include an underlining of a portion of text of the published work.

11. The method of claim 1, wherein the facilitating a sale or offer for sale of the selected one or more goods or services comprises directing a user to an interface for electronically purchasing the selected one or more goods or services.

12. The method of claim 11, wherein the interface for electronically purchasing the selected one or more goods or services arranges purchase of the selected one or more goods or services through a vendor of the selected one or more goods or services.

13. The method of claim 11, wherein vendor of the selected one or more goods or services comprises at least one of eBay, iTunes, and Amazon.

14. The method of claim 11, wherein the interface for electronically purchasing the selected one or more goods or services comprises a website.

15. The method of claim 11 wherein the goods or services are from specific vendors and the interface for electronically purchasing the selected one or more goods or services comprises an interface for purchasing the selected one or more goods or services from the specific vendors.

16. The method of claim 1, wherein the published work is linked to a geographic location with a geographic positioning device.

17. The method claim 16, further including the steps of providing a graphical user interface including a representation of a geographic area, providing selectable identifications of one or more published works relating to locations within the geographic area that contain the one or more references or representations of goods or services, receiving a selection of the one or more published works, facilitating transmission of the one or more published works to computer-readable memory, and facilitating display of the one or more published articles.

18. The method of claim 17 wherein the method further comprises providing the physical location of the mobile electronic device within the geographic area.

19. The method of claim 18 wherein the physical location of the mobile electronic device is provided by a geographic positioning device that is at least one of a GPS locating system and cellular locating system.

20. The method of claim 17 wherein providing to a user a graphical user interface comprises providing navigation within the geographic area through the geographic positioning device.

21. The method of claim 17 wherein the representation of the geographic area comprises a nautical chart representing a body of water.

22. The method of claim 17 wherein providing the selectable identifications of one or more published articles comprises providing selectable identifications of one or more published articles pertaining to at least one geographic location proximate the physical location of the mobile electronic device.

23. The method of claim 17 wherein the one or more published articles are related to recreational activities and the one or more references or representations of goods or services are related to the recreational activities.

24. The method of claim 23 wherein the one or more published articles and goods or services are related to the amenities pertaining to at least one of boating and fishing.

25. The method of claim 24 wherein the one or more published articles and goods or services are related to at least one of boating accessories, boat maintenance, boat testing, cooking, cruising, diving, fishing, kayaking, lifestyle, power boating, and sailing.

26. The method of claim 17 wherein the one or more published articles are related to tourism.

27. The method of claim 26 wherein the published works are related to at least one of a tourist destination, shopping, and restaurants.

28. The method of claim 16 further comprising a step of displaying at least one type of selectable graphical icon representing at least one type of published work, wherein the icon is positioned and displayed within the representation of the geographic area.

29. The method of claim 28 wherein the selectable graphical icon is positioned to be over or directly proximal to a particular area within the representation of the geographic area about which the corresponding published work pertains to.

30. The method of claim 16 wherein the one or more published works are related to the geographic area by at least one of reference in the published work to the geographic area, an activity in the geographic area, or a pre-established relationship.

31. The method of claim 1, further including the steps of providing selectable identifications of one or more published works and goods or services relating to at least one topic, receiving a selection of the one or more published works, facilitating transmission of the one or more published works to computer-readable memory, and facilitating display of the one or more published works.

32. The method of claim 1 wherein providing a graphical user interface includes providing to a user a representation of a published work through a mobile electronic device.

33. The method of claim 32 wherein the mobile device comprises at least one of a GPS, mobile telephone, hand-held computer, and eReader.

34. The method of claim 1 wherein the graphical user interface provides a field for inputting one or more search terms and wherein the method further comprises searching the one or more published works for the one or more search terms and identifying which of the published works contains at least one or more of the one or more inputted search terms.

35. The method of claim 34 further comprising identifying which of the published works include one or more of the inputted search terms in the one or more references or representations of goods or services.

36. The method of claim 1 wherein, providing selectable links within the representation of the published work to the one or more references or representation of goods or services comprises identifying references or representations of goods or services within the published work and establishing a selectable link to the references or representations of goods or services within the published work.

37. The method of claim 36 wherein identifying the references or representations of goods or services within the published work comprises an automated search of text within the published work for references or representations of the goods or services and establishing a selectable link between the references or representations and the identified goods or services.

38. A method of providing publications and products and services linked to geographical locations, the method comprising:
providing to a user a graphical user interface as a part of an electronic device, the graphical user interface including a representation of a geographic area;
providing navigation aids that are linked to the geographic area;
providing selectable identifications of one or more published articles related to the geographic area;
providing links to references or representations of goods or services within the one or more published articles;
receiving a selection of the one or more published articles;
facilitating transmission and display of a selected published article;
highlighting and permitting a selection of the links to the references of goods and services within the representation of the selected published article;
receiving a selection of at least one of the selectable links to the references of goods and services; and
facilitating a sale or offer for sale of the selected goods or services.

39. The method of claim 38 further providing a geographic positioning system linked to the geographic area, and providing navigation aids that are linked to the geographic area and data from the geographic positioning system.

40. The method of claim 38 further including providing a purchase option within the graphical user interface and facilitating payment by the user for the steps of facilitating transmission and display of the selected published article.

41. The method of claim 38 wherein the published articles include at least of one of a magazine article, newspaper article, manual, book, video and audio.

42. The method of claim 38 wherein the goods and services are related to at least one of boat maintenance, boat test, cooking, cruising, diving, fishing, kayaking, lifestyle, power boating, and sailing.

43. The method of claim 38 wherein the published articles include advertisements for products available within a range of the location of the electronic device.
